(19) United States
(12) Patent Application Publication
(10) Pub. No.: US 2024/0181436 A1
(43) Pub. Date: Jun. 6, 2024

(54) SINGLE ATOM CATALYST FOR ELECTROCHEMICAL CARBON DIOXIDE CONVERSION AND METHOD OF PREPARING THE SAME

(71) Applicant: KOREA INSTITUTE OF ENERGY RESEARCH, Daejeon (KR)

(72) Inventors: Young-eun KIM, Daejeon (KR); Wonhee LEE, Daejeon (KR); You Na KO, Daejeon (KR); Hak-joo KIM, Daejeon (KR)

(73) Assignee: KOREA INSTITUTE OF ENERGY RESEARCH, Daejeon (KR)

(21) Appl. No.: 18/519,903

(22) Filed: Nov. 27, 2023

(30) Foreign Application Priority Data
Nov. 28, 2022 (KR) 10-2022-0161293
Oct. 24, 2023 (KR) 10-2023-0142773

(51) Int. Cl. B01J 27/24; B01J 27/20; B01J 37/04; B01J 37/08; C01B 32/40

(52) U.S. Cl. CPC B01J 27/24; B01J 27/20; B01J 37/04; B01J 37/08; C01B 32/40

(57) ABSTRACT

A single atom catalyst for carbon dioxide conversion which allows mass production at low cost without performing a pretreatment of a carbon support and a post-treatment of a final synthesized catalyst is prepared. The single atom catalyst for carbon dioxide conversion was confirmed to have a low metal content to reduce production costs, and to have high carbon monoxide selectivity, carbon monoxide production rate, and stability.

### CROSS-REFERENCE TO RELATED APPLICATIONS

This application claims priority to Korean Patent Application No. 10-2022-0161293 filed Nov. 28, 2022, and Korean Patent Application No. 10-2023-0142773 filed Oct. 24, 2023, the disclosures of which are hereby incorporated by reference in its entirety.

### TECHNICAL FIELD

The following disclosure relates to a method of preparing a single atom catalyst for carbon dioxide conversion having excellent carbon monoxide selectivity and production rate during a carbon dioxide reduction reaction.

### BACKGROUND

It was reported that an electrochemical catalyst for carbon dioxide conversion has high selectivity and activity mainly in a metal-based catalyst, and the selectivity of each reduced product varies depending on the type of metal. In particular, in the case of a reduction catalyst for producing synthetic gas including carbon monoxide and hydrogen, precious metals such as gold and silver are mainly used due to their high selectivity and production rate and development of catalysts which may replace high-priced precious metals is demanded.

Since a single atom catalyst may significantly lower an amount of metal used to maximize a use of an active site and have excellent performance on a carbon dioxide reduction reaction, it has been studied a lot recently. Among them, transition metals such as nickel, cobalt, iron, copper, or manganese have high carbon monoxide and hydrogen selectivity, and in particular, since a nickel single atom catalyst shows high carbon monoxide and hydrogen selectivity under a high current density condition, it was reported as a promising material.

However, its low stability in an electrochemical carbon dioxide reduction reaction and the complexity of a catalyst preparation process act as an obstacle to industrial application. Methods of synthesizing a single atom catalyst reported so far require pretreatment and post-treatment (mainly acid treatment) processes for introducing a single atom to a nanoparticle or structure and have a small amount of catalyst synthesized, and thus, there is a difficulty in its mass production process.

### SUMMARY

An embodiment of the present invention is directed to providing a method of preparing a single atom catalyst for carbon dioxide conversion which allows mass production at low cost without performing a pretreatment of a carbon support and a post-treatment of a final synthesized catalyst.

Another embodiment of the present invention is directed to providing a single atom catalyst for carbon dioxide conversion which has s a high carbon monoxide selectivity and high carbon monoxide production rate and stability in a carbon dioxide reduction reaction while having a low metal content.

In one general aspect, a method of preparing a single atom catalyst for carbon dioxide conversion includes: dispersing a carbon support in a first solvent to prepare a carbon support solution; mixing a metal ion precursor and a metal ion-bonded precursor with a second solvent to prepare a metal ion precursor solution; mixing and reacting the carbon support solution, the metal ion precursor solution, and a nitrogen-containing material to prepare a single atom composite solution; drying the single atom composite solution to prepare a single atom composite including a carbon support and a metal ion; and heat-treating the single atom composite to prepare a single atom catalyst, wherein the metal ion is bonded in the form of a single atom on the carbon support.

In the method of preparing a single atom catalyst for carbon dioxide conversion according to the present invention, the metal ion may be bonded in the form of a single atom and a nanoparticle on the carbon support.

In the method of preparing a single atom catalyst for carbon dioxide conversion according to the present invention, the nitrogen-containing material may include a multipolymer of cyanimide and a derivative thereof.

In the method of preparing a single atom catalyst for carbon dioxide conversion according to the present invention, the nitrogen-containing material may include one or more sulfur (S) atoms.

In the method of preparing a single atom catalyst for carbon dioxide conversion according to the present invention, the nitrogen-containing material may include thiourea or a derivative thereof.

In the method of preparing a single atom catalyst for carbon dioxide conversion according to the present invention, the heat treatment may be performed at a temperature of 600 to 900° C. under an inert gas atmosphere.

In the method of preparing a single atom catalyst for carbon dioxide conversion according to the present invention, the heat treatment may be performed by indirect heating inside a container provided with a cover on the upper portion, from which produced gas may slowly escape during the heat treatment.

In the method of preparing a single atom catalyst for carbon dioxide conversion according to the present invention, the reaction in the preparing of a single atom composite solution may be performed by heating with refluxing at a temperature of 40 to 80° C.

In the method of preparing a single atom catalyst for carbon dioxide conversion according to the present invention, the carbon support may be selected from the group consisting of carbon black, acetylene black, Ketjen black, Denka black, thermal black, channel black, furnace black, lamp black, carbon nanofiber, graphene, graphene nanoribbon, fullerene, single-walled carbon nanotube, double-walled carbon nanotube, multi-walled carbon nanotube, graphite, graphite nanofiber, and fullerene.

In the method of preparing a single atom catalyst for carbon dioxide conversion according to the present invention, the carbon support may be doped with one or more non-metal elements selected from nitrogen, oxygen, boron, phosphorus, and sulfur.

In the method of preparing a single atom catalyst for carbon dioxide conversion according to the present invention, the metal ion may be one or more selected from the group consisting of a nickel ion, a cobalt ion, an iron ion, a copper ion, and a manganese ion.

In another general aspect, a single atom catalyst for carbon dioxide conversion includes: a carbon support; a nitrogen atom; and one or more metal atoms positioned on the carbon support.

In the single atom t for carbon dioxide conversion according to the present invention, the metal atom may be positioned in a dispersed state in a single atom form on the carbon support and may not be in contact with other metal elements.

In the single atom catalyst for carbon dioxide conversion according to the present invention, the nitrogen atom may be positioned on a surface of the carbon support, and the metal element may coordinate with the nitrogen atom.

In the single atom catalyst for carbon dioxide conversion according to the present invention, the single atom catalyst for carbon dioxide conversion may have a carbon monoxide selectivity of 20% or more during a carbon dioxide reduction reaction.

In the single atom catalyst for carbon dioxide conversion according to the present invention, a product from the carbon dioxide reduction reaction may include hydrogen and carbon monoxide.

In the single atom catalyst for carbon dioxide conversion according to the present invention, the single atom catalyst for carbon dioxide conversion may selectively control a ratio of hydrogen: carbon monoxide during the carbon dioxide reduction reaction.

Other features and aspects will be apparent from the following detailed description, the drawings, and the claims.

### BRIEF DESCRIPTION OF THE DRAWINGS

FIG. 1 is a drawing summarizing nickel contents and experiment conditions of single atom catalysts for carbon dioxide conversion according to Example 1 (1.37Ni—N2-C), Example 2 (1.50Ni—N1-C), Example 3 (3.02Ni—N3-C), Example 4 (1.81Ni—N3-C), Example 5 (2.04Ni—N3-C), Example 6 (3.44Ni—N3-C) Example 7 (1.71Ni—NV2-C), Example 8 (3.31Ni—NV3-C), Example 9 (1.70Ni—NC-2), Example 10 (1.60Ni—NSC-1), Example 11 (1.61Ni—NSC-2), Example 12 (1.63Ni—NSC-3), Comparative Example 1 (0.53Ni—N—C), Comparative Example 2 (1.22Ni—N—C), Comparative Example 3 (2.2Ni—N—C), and Comparative Example 4 (1.55Ni—NV—C), respectively. The nickel content was analyzed by inductively coupled plasma mass spectrometry.

FIG. 2 is a drawing showing the results of X-ray diffraction analysis of the single atom catalysts for carbon dioxide conversion of Comparative Example 2 (1.22Ni—N—C), Example 1 (1.37Ni—N2-C), Example 2 (1.50Ni—N1-C), and Example 3 (3.02Ni—N3-C).

FIG. 3 is a drawing showing images of the single atom catalyst for carbon dioxide conversion of Comparative Example 2 (1.22Ni—N—C) taken by a scanning electron microscope (upper left) and energy dispersive spectrometry (upper right and lower whole).

FIG. 4 is a drawing showing images of the single atom catalyst for carbon dioxide conversion of Example 1 (1.37Ni—N2-C) taken by a scanning electron microscope (upper left) and energy dispersive spectrometry (upper right and lower whole).

FIG. 5 is a drawing showing images of the single atom catalyst for carbon dioxide conversion of Example 2 (1.50Ni—N1-C) taken by a scanning electron microscope (upper left) and energy dispersive spectrometry (upper right and lower whole).

FIG. 6 is a drawing showing images of the single atom catalyst for carbon dioxide conversion of Example 3 (3.02Ni—N3-C) taken by a scanning electron microscope (upper left) and energy dispersive spectrometry (upper right and lower whole).

FIG. 7 is a drawing showing (a) a scanning electron microscope image, (b) a transmission electron microscope image, (c) a high resolution transmission electron microscope image, and (d) an atomic unit analysis scanning transmission electron microscope image, and (e) an image analyzed by transmission electron microscope energy dispersive spectrometry, of the single atom catalyst for carbon dioxide conversion of Comparative Example 2 (1.22Ni—N—C).

FIG. 8 is a drawing showing (a) a scanning electron microscope image, (b) a transmission electron microscope image, (c) a high resolution transmission electron microscope image, (d) an atomic unit analysis scanning transmission electron microscope image, and (e) an image analyzed by transmission electron microscope energy dispersive spectrometry, of the single atom catalyst for carbon dioxide conversion of Example 1 (1.37Ni—N2-C).

FIG. 9 is a drawing showing (a) a scanning electron microscope image, (b) a transmission electron microscope image, (c) a high resolution transmission electron microscope image, (d) an atomic unit analysis scanning transmission electron microscope image, and (e) an image analyzed by transmission electron microscope energy dispersive spectrometry, of the single atom catalyst for carbon dioxide conversion of Example 2 (1.50Ni—N1-C).

FIG. 10 is a drawing showing (a) a scanning electron microscope image, (b) a transmission electron microscope image, (c) a high resolution transmission electron microscope image, (d) an atomic unit analysis scanning transmission electron microscope image, and (e) an image analyzed by transmission electron microscope energy dispersive spectrometry, of the single atom catalyst for carbon dioxide conversion of Example 3 (3.02Ni—N3-C).

FIG. 11 is a drawing showing the results of X-ray photoelectron spectroscopy analysis of the single atom catalysts for carbon dioxide conversion of Comparative Example 2 (1.22Ni—N—C), Example 1 (1.37Ni—N2-C), Example 2 (1.50Ni—N1-C), and Example 3 (3.02Ni—N3-C).

FIG. 12 is a drawing showing the results of X-ray diffraction analysis of the single atom catalysts for carbon dioxide conversion of Example 3 (3.02Ni—N3-C), Example 4 (1.81Ni—N3-C), Example 5 (2.04Ni—N3-C), and Example 6 (3.44Ni—N3-C).

FIG. 13 is a drawing showing (a) a scanning electron microscope image, (b) a transmission electron microscope image, (c) a high resolution transmission electron microscope image, (d) an atomic unit analysis scanning transmission electron microscope image, and (e) an image analyzed by transmission electron microscope energy dispersive spectrometry, of the single atom catalyst for carbon dioxide conversion of Example 4 (1.81Ni—N3-C).

FIG. 14 is a drawing showing (a) a scanning electron microscope image, (b) a transmission electron microscope image, (c) a high resolution transmission electron microscope image, (d) an atomic unit analysis scanning transmission electron microscope image, and (e) an image analyzed by transmission electron microscope energy dispersive spectrometry, of the single atom catalyst for carbon dioxide conversion of Example 6 (3.44Ni—N3-C).

FIG. 15 is a drawing showing carbon monoxide (CO)/hydrogen (H₂) selectivity (FE, left) and carbon monoxide (CO)/hydrogen (H₂) production rate (j_{product}, right) of the single atom catalysts dioxide conversion of Comparative Example 2 (1.22Ni—N—C), Example 1 (1.37Ni—N2-C), Example 2 (1.50Ni—N1-C), and Example 3 (3.02Ni—N3-C).

FIG. 16 is a drawing showing the catalysts of Comparative Example 2 (1.22Ni—N—C), Example 1 (1.37Ni—N2-C), Example 2 (1.50Ni—N1-C), Example 3 (3.02Ni—N3-C), and Comparative Example 5 (silver nanoparticles, Ag Nps) analyzed using electrochemical impedance spectroscopy.

FIG. 17 is a drawing showing stability of carbon monoxide conversion of the single atom catalyst for carbon dioxide conversion according to Example 3 (3.02Ni—N3-C) analyzed with cell voltage (left y axis) and selectivity (FE, right y axis) over time under −100 mA·cm⁻² constant current conditions using a Fumasep FAA-3-50 anion exchange membrane.

FIG. 18 is a drawing showing stability of carbon monoxide conversion of the single atom catalyst for carbon dioxide conversion according to Example 3 (3.02Ni—N3-C) analyzed with cell voltage (left y axis) and carbon monoxide selectivity (FE, right y axis) over time under −100 mA·cm⁻² constant current conditions using a Dioxide Materials Sustainion X37-50 grade T anion exchange membrane.

FIG. 19 is a drawing showing carbon monoxide (CO)/hydrogen (H₂) selectivity (FE, left) and carbon monoxide (CO)/hydrogen (H₂) production rate (j_{product}, right) of the single atom catalysts dioxide conversion of Example 3 (3.02Ni—N3-C 700), Example 4 (1.81Ni—N3-C 600), Example 5 (Ni—N3-C 800), and Example 6 (3.44Ni—N3-C 900).

FIG. 20 is a drawing showing the results of X-ray diffraction analysis of the single atom catalysts for carbon dioxide conversion of Comparative Example 1 (0.53Ni—N—C), Comparative Example 2 (1.22Ni—N—C), and Comparative Example 3 (2.22Ni—N—C).

FIG. 21 is a drawing showing the results of X-ray photoelectron spectroscopy analysis of the single atom catalysts for carbon dioxide conversion of Comparative Example 1 (0.53Ni—N—C), Comparative Example 2 (1.22Ni—NJ—C), and Comparative Example 3 (2.22Ni—N—C).

FIG. 22 is a drawing showing carbon monoxide (CO)/hydrogen (H₂) selectivity (FE, left) and carbon monoxide (CO)/hydrogen (H) production rate (j_{product}, right) of the single atom catalysts for carbon dioxide conversion of Comparative Example 1 (0.53Ni—N—C), Comparative Example 2 (1.22Ni—N—C), and Comparative Example 3 (2.22Ni—N—C).

FIG. 23 is a drawing showing carbon monoxide (CO)/hydrogen (H₂) selectivity (FE, left) and carbon monoxide (CO)/hydrogen (H₂) production rate (j_{product}, right) of the single atom catalysts for carbon dioxide conversion of Example 7 (1.71Ni—NV2-C), Comparative Example 4 (1.55Ni—NV—C), Example 1 (1.37Ni—N2-C), and Comparative Example 2 (1.22Ni—N—C).

FIG. 24 is a drawing showing carbon monoxide (CO)/hydrogen (H₂) selectivity (FE, left) and carbon monoxide (CO)/hydrogen (H₂) production rate (j_{product}, right) of the single atom catalysts for carbon dioxide conversion of Example 8 (3.31Ni—NV3-C), Comparative Example 4 (1.55Ni—NV—C), Example 3 (3.02Ni—N3-C), and Comparative Example 2 (1.22Ni—N—C).

FIG. 25 is a drawing showing the results of X-ray diffraction analysis of the single atom catalysts for carbon dioxide conversion of Example 9 (1.70Ni—NC-2), Example 10 (1.60Ni—NSC-1), Example 11 (1.61Ni—NSC-2), and Example 12 (1.63Ni—NSC-3).

FIG. 26 is a drawing showing the results of analyzing the single atom catalyst for carbon dioxide conversion according to Example 9 (1.70Ni—NC-2) with (a) a scanning electron microscope, (b) a transmission electron microscope, (c) a high resolution transfer electron microscope, (d) a high angle annular dark field scanning transmission electron microscope, and (e) energy dispersive X-ray spectroscopy (C is a carbon atom; O is an oxygen atom, N is a nitrogen atom, and Ni is a nickel atom, respectively).

FIG. 27 is a drawing showing the results of analyzing the single atom catalyst for carbon dioxide conversion according to Example 10 (1.60Ni—NSC-1) with (a) a scanning electron microscope, (b) a transmission electron microscope, (c) a high resolution transfer electron microscope, (d) a high angle annular dark field scanning transmission electron microscope, and (e) energy dispersive X-ray spectroscopy (C is a carbon atom; O is an oxygen atom, N is a nitrogen atom, and Ni is a nickel atom, respectively).

FIG. 28 is a drawing showing the results of analyzing the single atom catalyst for carbon dioxide conversion according to Example 11 (1.61Ni—NSC-2) with (a) a scanning electron microscope, (b) a transmission electron microscope, (c) a high resolution transfer electron microscope, (d) a high angle annular dark field scanning transmission electron microscope, and (e) energy dispersive X-ray spectroscopy (C is a carbon atom; O is an oxygen atom, N is a nitrogen atom, and Ni is a nickel atom, respectively).

FIG. 29 is a drawing showing the results of analyzing the single atom catalysts for carbon dioxide conversion according to Example 12 (1.63Ni—NSC-3) with (a) a scanning electron microscope, (b) a transmission electron microscope, (c) a high resolution transfer electron microscope, (d) a high angle annular dark field scanning transmission electron microscope, and (e) energy dispersive X-ray spectroscopy (C is a carbon atom; O is an oxygen atom, N is a nitrogen atom, and Ni is a nickel atom, respectively).

FIG. 30 is a drawing showing carbon monoxide (CO)/hydrogen (H₂) selectivity (FE, left) and carbon monoxide (CO)/hydrogen (H₂) production rate (j_{product}, right) of the single atom catalysts for carbon dioxide conversion according to Example 9 (1.70Ni—NC-2), Example 10 (1.60Ni—NSC-1), Example 11 (1.61Ni—NSC-2), and Example 12 (1.63Ni—NSC-3).

### DETAILED DESCRIPTION OF EMBODIMENTS

The embodiments described in the present specification may be modified in many different forms, and the technology according to an exemplary embodiment is not limited to the embodiments set forth herein. In addition, the embodiments of an exemplary embodiment are provided so that the present disclosure will be described in more detail to a person with ordinary skill in the art. Technical terms and scientific terms used herein have the general meaning understood by those skilled in the art to which the present invention pertains unless otherwise defined, and a description for the known function and configuration which may unnecessarily obscure the gist of the present invention will be omitted in the following description and the accompanying drawings.

In addition, the singular form used in the specification and claims appended thereto may be intended to also include a plural form, unless otherwise indicated in the context.

In addition, in the present specification and the appended claims, when it is said that a part such as a film (layer), a domain, or a constituent element is positioned “on”, “in the upper portion”, “in the upper stage”, “under”, “in the lower portion”, or “in the lower stage”, it includes not only the case in which one part is in contact with the other part, but also the case in which there is another part between two parts.

In addition, the terms “about”, “substantially”, and the like used in the present specification and the appended claims are used in the meaning of the numerical value or in the meaning close to the numerical value when unique manufacture and material allowable errors are suggested in the mentioned meaning, and are used for preventing the disclosure mentioning a correct or absolute numerical value for better understanding of the present application from being unfairly used by an unconscionable infringer.

In addition, the terms such as “first” and “second” used in the present specification and the appended claims are not used in a limited meaning but are used for the purpose of distinguishing one constituent element from other constituent elements.

In addition, throughout the present specification, “step of doing” or “step of something” does not mean “step for something”.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms.

In addition, unless otherwise particularly defined in the specification of the present invention, values which may be outside a numerical range due to experimental error or rounding off of a value are also included in the defined numerical range.

Furthermore, in the present specification and the appended claims, the terms such as “comprise” or “have” mean that there is a characteristic or a constituent element described in the specification, and as long as it is not particularly limited, a possibility of adding one or more other characteristics or constituent elements is not excluded in advance.

Hereinafter, a method of preparing a single atom catalyst for carbon dioxide conversion of the present invention and a single atom catalyst for carbon dioxide conversion using the method of preparing a single atom catalyst for carbon dioxide conversion will be described in detail.

A method of preparing a single atom catalyst for carbon dioxide conversion according to an exemplary embodiment includes: dispersing a carbon support in a first solvent to prepare a carbon support solution; mixing a metal ion precursor and a metal ion-bonded precursor with a second solvent to prepare a metal ion precursor solution; mixing and reacting the carbon support solution, the metal ion precursor solution, and a nitrogen-containing material to prepare a single atom composite solution; drying the single atom composite solution to prepare a single atom composite; and heat-treating the single atom composite to prepare a single atom catalyst, wherein the metal ion is a transition metal having a carbon monoxide selectivity of 20% or more during a carbon dioxide reduction reaction, and the metal ion is bonded in the form of a single atom on the carbon support.

Specifically, the metal ion is a metal ion having a carbon monoxide selectivity, and the metal ion is contained in the form of a single atom or nanoparticle on the carbon support to serve as an active site of the single atom catalyst for carbon dioxide conversion. The metal ion may have a carbon monoxide selectivity during a carbon dioxide reduction reaction of 20% or more, 30% or more, 40% or more, or 50% or more, and as the upper limit, 99% or less, 90% or less, 80% or less, or 70% or less. Specifically, the carbon monoxide selectivity during the carbon dioxide reduction reaction of the metal ion may be 20 to 99%, 30 to 99%, specifically 40 to 99%, advantageously, 50 to 95%.

According to an exemplary embodiment, during the carbon dioxide reduction reaction in the aqueous solution with the metal ion, water included in the aqueous solution is reduced together, in which the metal ion may be a metal ion having a selectivity for a hydrogen ion (H⁺) to produce hydrogen gas (H₂). Specifically, water included in the aqueous solution may be reduced together during the carbon dioxide reduction reaction in the aqueous solution with the metal ion. During the reduction of water, a hydrogen selectivity may be 1% or more, 2% or more, or 5% or more, and as the upper limit, 80% or less, 70% or less, 60% or less, or 50% or less. Specifically, the metal ion may have a selectivity of hydrogen for the reduction reaction of water during the carbon dioxide reduction reaction in the aqueous solution of 1 to 80%, 2 to 70%, 5 to 60%, or 5 to 50%.

According to an exemplary embodiment, the metal ion may produce both carbon monoxide and hydrogen during the carbon dioxide reduction reaction in the aqueous solution. Therefore, the single atom catalyst for carbon dioxide conversion prepared by the method of preparing a single atom catalyst for carbon dioxide conversion may produce a product containing both carbon monoxide and hydrogen, that is, a synthetic gas during the carbon dioxide reduction reaction in the aqueous solution.

According to an exemplary embodiment, since a reduction potential for producing hydrogen and a reduction potential for producing carbon monoxide during the carbon dioxide reduction reaction in the aqueous solution may be different, the selectivity of carbon monoxide and the selectivity of hydrogen may adjust a production amount of carbon monoxide and a production amount of hydrogen depending on cell voltage applied to the single atom catalyst for carbon dioxide conversion.

The metal ion according to an exemplary embodiment may be one or more selected from the group consisting of a nickel ion, a cobalt ion, an iron ion, a copper ion, and a manganese ion. The single atom catalyst for carbon dioxide conversion of the present invention includes the metal ion described above, thereby having a high carbon monoxide selectivity, high stability, and a high production rate.

The metal ion according to an exemplary embodiment may be one or more selected from the group consisting of transition metals. As the metal ion, a metal ion having a selectivity of carbon monoxide of 20% or more may be appropriately selected from the group consisting of metal ions.

A metal ion-bonded precursor according to an exemplary embodiment is a material forming a chemical bond with the metal ion, and forms a coordination bond or a covalent bond with the metal ion to serve to support the metal ion on the carbon support. Thereafter, the metal ion may be bonded in the form of a single atom or a nanoparticle on the carbon support by a heat treatment and the like.

The metal ion-bonded precursor according to an exemplary embodiment may be mixed for providing an anchoring site for the single atom catalyst for carbon dioxide conversion of the present invention. As a favorable example, the metal ion-bonded precursor may be 1,10-phenanthroline monohydrate, but the present invention is not limited thereto, and may be a molecule having a structure appropriate for providing the anchoring site of the metal ion.

The first solvent according to an exemplary embodiment may be a solvent which may be uniformly disperse the carbon support. The first solvent may be any solvent which may disperse the carbon support to form a colloid solution without being reacted with the carbon support. As a favorable example, the first solvent may be alcohol such as ethanol, and may be any polar solvent which may dissolve the metal ion precursor and a nitrogen-containing material, but the present invention is not limited thereto.

The second solvent according to an exemplary embodiment may be a solvent which may uniformly disperse the metal ion precursor and the metal ion-bonded precursor. The second solvent does not chemically react with the metal ion precursor and the metal ion-bonded precursor, and may be any solvent in which the metal ion precursor and the metal ion-bonded precursor are dispersed well. As a favorable example, the second solvent may be alcohol such as ethanol, but the present invention is not limited thereto, and the first solvent and the second solvent may be the same solvent.

The metal ion according to an exemplary embodiment may be bonded to the carbon support structure in the form of a nanoparticle. Specifically, the metal ion may be bonded to the carbon support structure in the form of a single atom or a nanoparticle, and the metal ion form may be adjusted to adjust the metal ion content and change the properties of the single atom catalyst for carbon dioxide conversion. However, as a favorable example, the metal ion may be all bonded to the carbon support structure in the form of a single atom, and when the metal ion is all bonded to the carbon support structure in the form of a single atom, the amount of the metal ion used may be decreased, and the specific surface area of the active site may be increased.

The nitrogen-containing material according to an exemplary embodiment may include a multipolymer of cyanamide or a thereof. Specifically, the nitrogen-containing material is added for adjusting the nitrogen content of the single atom catalyst for carbon dioxide conversion, and the properties of the single atom catalyst for carbon dioxide conversion may vary depending on the nitrogen content and the coordination properties of the single atom catalyst for carbon dioxide conversion. As a favorable example, the nitrogen-containing material may be a multipolymer of cyanamide or a derivative thereof, and the nitrogen-containing material may be used as the multipolymer of cyanamide or the derivative thereof to appropriately adjust the nitrogen doping amount and the coordination properties of the single atom catalyst for carbon dioxide conversion. More favorably, the nitrogen-containing material may be 1,3,5-triazine-2,4,6-triamine which is a triple polymer of cyanamide.

According to an exemplary embodiment, the nitrogen-containing material may include one or more sulfur atoms. As an example, the nitrogen-containing material may be thiourea satisfying the following Chemical Formula 1 and a derivative thereof:

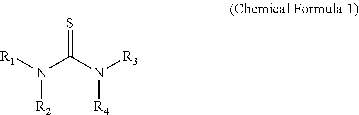

wherein R₁ to R₄ are independently of each other alkyl or aryl having 1 to 20 carbon atoms.

When the nitrogen-containing material is the multipolymer of cyanamide or the derivative thereof; or thiourea satisfying Chemical Formula 1 or the derivative thereof, the nitrogen doping amount and the coordination properties of the single atom catalyst for carbon dioxide conversion may be appropriately adjusted.

According to exemplary an embodiment, the multipolymer of cyanamide or the derivative thereof; and the thiourea satisfying Chemical Formula 1 or the derivative thereof may be properly mixed and mixed with the carbon support solution and the metal ion precursor solution. Specifically, the nitrogen-containing material may be a mixture of the multipolymer of cyanamide or the derivative thereof; and the thiourea satisfying Chemical Formula 1 or the derivative thereof at a ratio of 1:9, 2:8, 3:7, 4:6, 5:5, 4:6, 3:7, 2:8, or 1:9. The nitrogen-containing material may be a mixture of two or more chemical species including the nitrogen-containing material at the above-described ratio, and the mixing ratio may be appropriately selected depending on the properties of each of the two or more chemical species.

The heat treatment according to an exemplary embodiment may be performed under an inert active gas atmosphere. Since the heat treatment is performed under the inert gas atmosphere, a yield of the single atom catalyst for carbon dioxide conversion may be high, and a side reaction during the preparation of the single atom catalyst for carbon dioxide conversion may be suppressed to achieve a high yield and a high production amount.

The heat treatment according to an exemplary embodiment may be performed at a temperature of 600 to 900° C.

The heat treatment according to an exemplary embodiment is provided with a cover on the upper portion, and may be performed with indirect heating inside a container from which produced gas may slowly escape.

Specifically, the container is provided with a cover on the upper portion and the cover may be removed when the single atom composite is added thereto, the cover is provided on the upper portion of the container after adding the single atom composite, and during the heat treatment, gas produced by decomposition of the nitrogen-containing material slowly escapes through the gap in the cover and remains inside the container at a high concentration, thereby facilitating nitrogen doping into the carbon support and fixing the metal ion on the carbon support well.

The container according to an exemplary embodiment may be a ceramic crucible, but is not limited thereto, and may be a container of any material and structure as long as the material and the structure may appropriately apply temperature to the single atom composite without physical loss and chemical reaction at the heat treatment temperature described above.

Specifically, the metal ion-bonded precursor is weakly bonded on the carbon support by a van der Walls attractive force, and then is decomposed by the heat treatment, so that the single atom catalyst for carbon dioxide conversion in which only the metal ion remains on the carbon support may be prepared. Herein, the temperature of the heat treatment may be any temperature at which the metal ion-bonded precursor is decomposed. The heat treatment temperature may vary depending on the chemical species of the bonded precursor, and may be 400° C. or higher, 500° C. or higher, or 600° C. or higher, and as the upper limit, 1200° C. or lower, 1000° C. or lower, or 900° C. or lower. Specifically, it may be 400 to 1200° C., specifically 500 to 1000° C., and favorably 600 to 900° C.

In addition, specifically, a heating rate of the heat treatment may be adjusted within an appropriate range having a rapid production rate without other side reactions of the carbon support and the metal ion-bonded precursor, and may be 0.1° C./min or more or 1° C./min or more, and as the upper limit, 50° C./min or less, 30° C./min or less, or 10° C./min or less. Specifically, it may be 0.1 to 50° C./min, specifically 1 to 30° C./min, and favorably 1 to 10° C./min, but is not limited thereto.

The reaction in the preparing of a single atom composite solution may be performed by heating with refluxing at a temperature of 40 to 80° C.

Specifically, the preparing of a single atom composite solution is bonding the metal ion precursor and the nitrogen-containing material on the carbon support, and the nitrogen doping amount and the metal ion content of the single atom catalyst for carbon dioxide conversion of the present invention may vary depending on the appropriate temperature and the reaction time. Therefore, the preparing of a single atom composite solution may be performed at a temperature of 20° C. or higher, 30° C. or higher, or 40° C. or higher, and as the upper limit, 120° C. or lower, 100° C. or lower, or 80° C. or lower. Specifically, it may be performed at a temperature of 20 to 120° C., specifically 30 to 100° C., and favorably 40 to 80° C.

In addition, specifically, the reaction in the preparing of a single atom composite solution may be performed with refluxing. Specifically, since the preparing of a single atom composite solution is performed with refluxing, a reaction time of the preparing of a single atom composite solution may be extended, and thus, the nitrogen doping amount and the metal ion content of the single atom catalyst for carbon dioxide conversion may be increased.

The carbon support according to an exemplary embodiment may be one or more selected from the group consisting of carbon black, graphene, and carbon nanotubes.

In addition, the carbon support according to an exemplary embodiment may be one or more selected from the group consisting of single-wall carbon nanotubes, double-wall carbon nanotubes, and multi-wall carbon nanotubes. Specifically, when the carbon support is the carbon nanotube described above, the metal ion may be appropriately supported, and the specific surface area and the active site content of the catalyst may be increased.

In addition, the carbon support according to an exemplary embodiment does not chemically react with the metal and may be a carbonaceous material having excellent electrical conductivity, and specifically, may be a carbon support formed of a carbon-based material such as zero-dimensional carbon; graphite such as natural graphite, artificial graphite, and graphite nanofiber; carbon blacks such as carbon black, acetylene black, Ketjen black, Denka black, thermal black, channel black, furnace black, and lamp black; carbonaceous materials of which the crystal structure is graphene or graphite; and fullerene, and may be any material as long as it has the physical properties and the shape to appropriately support the metal ion as a carbon site and may minimize deformation of a catalyst structure.

The carbon support according to an exemplary embodiment may be doped with one or more non-metal elements selected from nitrogen, oxygen, boron, phosphorus, and sulfur. Specifically, the non-metal element doped onto the carbon support may be a basic atom forming a bonding structure of the anchoring site which bonds the carbon support and the metal ion, and may be any non-metal element as long as it is a non-metal element to which the metal ion may be appropriately bonded. Favorably, the non-metal element may be nitrogen.

The present invention provides a single atom catalyst for carbon dioxide conversion, and the single atom catalyst for carbon dioxide conversion includes: a carbon support; a nitrogen atom; and one or more metal atoms positioned on the carbon support.

According to an exemplary embodiment, since the single atom catalyst for carbon dioxide conversion according to the present invention may be prepared by the method of preparing a single atom catalyst for carbon dioxide conversion described above, the single atom catalyst for carbon dioxide conversion of the present invention includes all of the above descriptions for the method of preparing a single atom catalyst for carbon dioxide conversion.

Hereinafter, the single atom catalyst for carbon dioxide conversion according to the present invention will be described in more detail.

According to an exemplary embodiment, the metal atom may be positioned in a dispersed state in a single atom form on the carbon support and may not be in contact with other metal elements. The metal ion is a metal ion having a carbon monoxide selectivity, and the metal ion is contained in the form of a single atom or a nanoparticle on the surface of the carbon support to serve as an active site of the single atom catalyst for carbon dioxide conversion. As a favorable example, the metal ion may be evenly dispersed in the form of a single atom which is not in contact with other metal element on the surface of the carbon support. When the metal ion is evenly dispersed in the form of a single atom, the activity of the single atom catalyst for carbon dioxide conversion may be high.

According to an exemplary embodiment, the nitrogen atom may be positioned on the surface of the carbon support, and the metal element may coordinate with the nitrogen atom. The nitrogen atom may be dispersed on the surface of the carbon support, and the metal atom may coordinate with the nitrogen atom and positioned on the surface of the carbon support in a complex form. As described above, the complex may be positioned in a single complex compound form, that is, in a form in which the single metal atom is dispersed on the surface of the carbon support.

According to an exemplary embodiment, the single atom catalyst for carbon dioxide conversion may have a carbon monoxide selectivity of 20% or more during a carbon dioxide reduction reaction. specifically, the single atom catalyst for carbon dioxide conversion may have a carbon monoxide selectivity during a carbon dioxide reduction reaction of 20% or more, 30% or more, 40% or more, or 50% or more, and as the upper limit, 99% or less, 90% or less, 80% or less, or 70% or less. Specifically, the carbon monoxide selectivity during the carbon dioxide reduction reaction of the metal ion may be 20 to 99%, 30 to 99%, 40 to 99%, or 50 to 99%.

According to an exemplary embodiment, the single atom catalyst for carbon dioxide conversion may have a selectivity to hydrogen during the reduction reaction of carbon dioxide of 2% or more. Specifically, during the carbon dioxide reduction reaction in an aqueous solution with the single atom catalyst for carbon dioxide conversion, water included in the aqueous solution may be reduced together. The single atom catalyst for carbon dioxide conversion may have a selectivity to hydrogen during reduction of water included in the aqueous solution of 1% or more, 2% or more, or 5% or more, and as the upper limit, 80% or less, 70% or less, 60% or less, or 50% or less. Specifically, the single atom catalyst for carbon dioxide conversion may have a selectivity to hydrogen for the reduction reaction of water during the carbon dioxide reduction reaction in the aqueous solution of 1 to 80%, 2 to 70%, 5 to 60%, or 5 to 50%.

According to an exemplary embodiment, the product from the carbon dioxide reduction reaction in the aqueous solution with the single atom catalyst for carbon dioxide conversion may include hydrogen (H₂) and carbon monoxide (CO). That is, the product from the carbon dioxide reduction reaction with single atom catalyst for carbon dioxide conversion may include a synthetic gas.

According to an exemplary embodiment, the single atom catalyst for carbon dioxide conversion may selectively control a ratio of hydrogen: carbon monoxide during the carbon dioxide reduction reaction. Specifically, the single atom catalyst for carbon dioxide conversion according to an exemplary embodiment may selectively control a ratio of carbon monoxide and hydrogen included in the product from the reduction reaction when the carbon dioxide reduction reaction is performed in an aqueous solution, through the change of the chemical species of the metal ion included in the single atom catalyst for carbon dioxide conversion; change of content of the metal ion; or change of the chemical species and the content of the metal ion.

As a non-limiting example, the contents of carbon monoxide and hydrogen of the product produced from the carbon dioxide reduction reaction of the single atom catalyst for carbon dioxide conversion may be 1 mol % or more, 2 mol % or more, 5 mol % or more, 10 mol % or more, 20 mol % or more, 30 molt or more, 50 mol % or more, 60 mol % or more, 70 mol % or more, 80 mol % or more, 90 mol % or more, or 100 mol % or more, and as a lower limit, 10,000 mol % or less, 9,000 mol % or less, 8,000 mol % or less, 7,000 mol % or less, 6,000 mol % or less, 5,000 mol % or less, 3,000 mol % or less, 2,000 mol % or less, 1,000 mol % or less, 500 mol % or less, or 200 mol % or less per 100 mol of the carbon monoxide. Specifically, the hydrogen may be included at 1 to 10,000 mol, 2 to 9,000 mol, 5 to 8,000 mol, 10 to 7,000 mol, 20 to 6,000 mol, 30 to 5,000 mol, 50 to 3,000 mol, 60 to 2,000 mol, 70 to 1,000 mol, 80 to 500 mol, 90 to 200 mol, or 100 to 200 mol per 100 mol of carbon dioxide. The product may satisfy the range described above, and the content ratio of carbon monoxide and hydrogen included in the product may be selectively controlled through change of the chemical species of the metal ion included in the single atom catalyst for carbon dioxide conversion; change of the content of the metal ion; or change of the chemical species and the content of the metal ion.

According to an exemplary embodiment of the present invention described above, the method of preparing a single atom catalyst for carbon dioxide conversion of the present invention and the single atom catalyst for carbon dioxide conversion of the present invention may be infinitely used in addition to the exemplary embodiments described above, and the claims described later and also all equivalent or equivalent modification to the claims belong to the scope of the ideas described in the present specification.

Hereinafter, the examples will be illustrated in detail. However, the examples described later are only illustrative of some, and the technology described in the present specification is not construed as being limited thereto.

### EXAMPLE 1

1 g of multi-walled carbon nanotubes were mixed with 55 ml of ethanol and sonication was performed for 1 hour to prepare a carbon support solution. Then, 85 mg of nickel (II) acetate tetrahydrate (Ni(OAc)₂·4H₂O), 204 mg of 1,10-phenanthroline monohydrate, and 1 g of 1,3,5-triazine-2,4,6-triamine were mixed with 25 ml of ethanol and stirring was performed for 30 minutes to prepare a metal ion precursor solution. Then, the carbon support solution, the metal ion precursor solution, and 15 ml of ethanol were mixed and stirring and reflux were performed at 50° C. for 4 hours to perform a reaction. Then, heat at 80° C. was applied to evaporate ethanol to obtain a single atom composite. Then, the single atom composite was loaded into an alumina crucible and a heat treatment was performed at a temperature of 700° C. for 2 hours under an inert gas (100 sccm of argon) atmosphere with the crucible covered with a cover. At this time, a heating rate was 5° C./min. Then, a single atom catalyst for carbon dioxide conversion was obtained in a crucible to finally prepare the single atom catalyst for carbon dioxide conversion.

### EXAMPLE 2

A single atom catalyst for carbon dioxide conversion was prepared in the same manner as in Example 1, except that the alumina crucible was covered with the cover during the heat treatment.

### EXAMPLE 3

A single atom catalyst for carbon dioxide conversion was prepared in the same manner as in Example 1, except that when the metal ion precursor solution was prepared, 170 mg of nickel (II) acetate tetrahydrate was used.

### EXAMPLE 4

A single atom catalyst for carbon dioxide conversion was prepared in the same manner as in Example 3, except that the heat treatment was performed at a temperature of 600° C.

### EXAMPLE 5

A single atom catalyst for carbon dioxide conversion was prepared in the same manner as in Example 3, except that the heat treatment was performed at a temperature of 800° C.

### EXAMPLE 6

A single atom catalyst for carbon dioxide conversion was prepared in the same manner as in Example 3, except that the heat treatment was performed at a temperature of 900° C.

### EXAMPLE 7

A single atom catalyst for carbon dioxide conversion was prepared in the same manner as in Example 1, except that 136 mg of 1,10-phenanthroline monohydrate was added to the metal ion precursor solution.

### EXAMPLE 8

A single atom catalyst for carbon dioxide conversion was prepared in the same manner as in Example 1, except that when the metal ion precursor solution was prepared, 170 mg of nickel (II) acetate tetrahydrate was used, and 136 mg of 1,10-phenanthroline monohydrate was added.

### EXAMPLE 9

A single atom catalyst for carbon dioxide conversion was prepared in the same manner as in Example 7, except that when the metal ion precursor solution was prepared, 0.7 g of 1,3,5-triazine-2,4,6-triamine and 0.3 g of thiourea were used instead of 1 g of 1,3,5-triazine-2,4,6-triamine.

### EXAMPLE 10

A single atom catalyst for carbon dioxide conversion was prepared in the same manner as in Example 7, except that when the metal ion precursor solution was prepared, 0.5 g of 1,3,5-triazine-2,4,6-triamine and 0.5 g of thiourea were used instead of 1 g of 1,3,5-triazine-2,4,6-triamine.

### EXAMPLE 11

A single atom catalyst for carbon dioxide conversion was prepared in the same manner as in Example 7, except that when the metal ion precursor solution was prepared, 0.3 g of 1,3,5-triazine-2,4,6-triamine and 0.7 g of thiourea were used instead of 1 g of 1,3,5-triazine-2,4,6-triamine.

### EXAMPLE 12

A single atom catalyst for carbon dioxide conversion was prepared in the same manner as in Example 7, except that when the metal ion precursor solution was prepared, 1 g of thiourea was used instead of 1 g of 1,3,5-triazine-2,4,6-triamine.

### COMPARATIVE EXAMPLE 1

A single atom catalyst for carbon dioxide conversion was prepared in the same manner as in Example 1, except that 1 g of 1,3,5-triazine-2,4,6-triamine was not added to the metal ion precursor solution, and 42.5 mg of nickel (II) acetate tetrahydrate and 102 mg of 1,10-phenanthroline monohydrate were added.

### COMPARATIVE EXAMPLE 2

A single atom catalyst form carbon dioxide conversion was prepared in the same manner as in Example 1, except that 1 g of 1,3,5-triazine-2,4,6-triamine was not added to the metal ion precursor solution.

### COMPARATIVE EXAMPLE 3

A single atom catalyst for carbon dioxide conversion was prepared in the same manner as in Example 1, except that 1 g of 1,3,5-triazin-2,4,6-triamine was not added to the metal ion precursor solution, and 127.5 mg of nickel (II) acetate tetrahydrate and 306 mg of 1,10-phenanthroline monohydrate were added.

### COMPARATIVE EXAMPLE 4

A single atom catalyst for carbon dioxide conversion was prepared in the same manner as in Example 1, except that 1 g of 1,3,5-triazine-2,4,6-triamine was not added to the metal ion precursor solution, and 136 mg of 10-phenanthroline monohydrate was added.

### COMPARATIVE EXAMPLE 5

Silver nanoparticles were used as a catalyst for carbon dioxide conversion.

### EXPERIMENTAL EXAMPLE 1

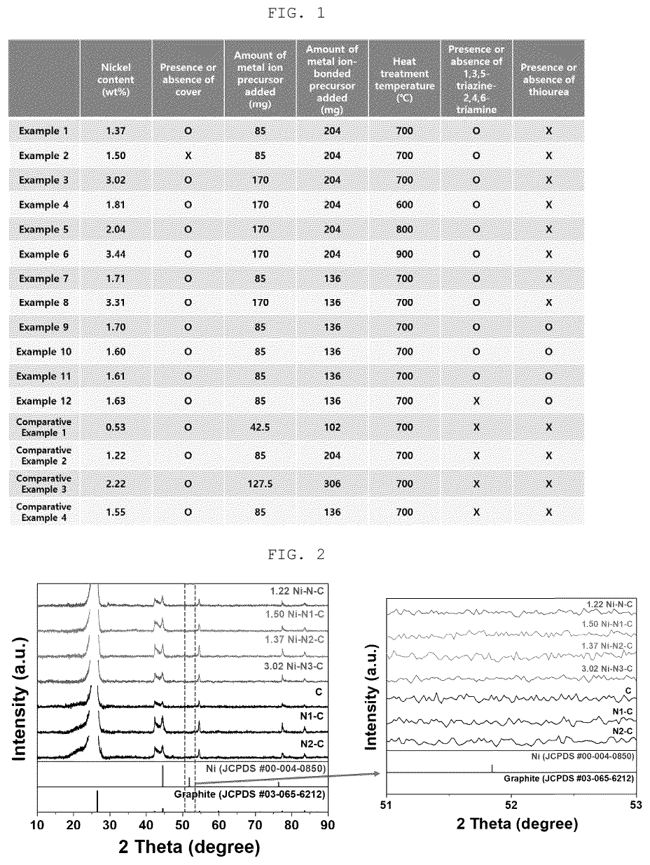

Nickel contents in the single atom catalysts for carbon dioxide conversion according to Examples 1 to 12 and Comparative Examples 1 to 4 were analyzed by inductively coupled plasma mass spectrometry to measure the nickel content in the single atom catalyst for carbon dioxide conversion of each example. The nickel content in the single atom catalyst for carbon dioxide conversion of Comparative Example 1 (0.53Ni—N—C) was measured as 0.53 wt %, the nickel content in the single atom catalyst for carbon dioxide conversion of Comparative Example 2 (1.22Ni—N—C) was measured as 1.22 wt %, the nickel content in the single atom catalyst for carbon dioxide conversion of Comparative Example 3 (2.22Ni—N—C) was measured as 2.22 wt %, the nickel content in the single atom catalyst for carbon dioxide conversion of Comparative Example 4 (1.55Ni—NV—C) was measured as 1.55 wt %, the nickel content in the single atom catalyst for carbon dioxide conversion of Example 1 (1.37 Ni—N2-C) was measured as 1.37 wt %, the nickel content in the single atom catalyst for carbon dioxide conversion of Example 2 (1.50Ni—N1-C) was measured as 1.50 wt %, the nickel content in the single atom catalyst for carbon dioxide conversion of Example 3 (3.02Ni—N3-C) was measured as 3.02 wt %, the nickel content in the single atom catalyst for carbon dioxide conversion of Example 4 (1.81Ni—N3-C 600) was measured as 1.81 wt %, the nickel content in the single atom catalyst for carbon dioxide conversion of Example 5 (2.04Ni—N3-C 800) was measured as 2.04 wt %, the nickel content in the single atom catalyst for carbon dioxide conversion of Example 6 (3.44Ni—N3-C 900) was measured as 3.44 wt %, the nickel content in the single atom catalyst for carbon dioxide conversion of Example 7 (1.71Ni—NV2-C) was measured as 1.71 wt %, the nickel content in the single atom catalyst for carbon dioxide conversion of Example 8 (3.31Ni—NV3-C) was measured as 3.31 wt %, the nickel content in the single atom catalyst for carbon dioxide conversion of Example 9 (1.70 Ni—NC-2) was measured as 1.70 wt %, the nickel content in the single atom catalyst for carbon dioxide conversion of Example 10 (1.60Ni—NSC-1) was measured as 1.60 wt %, the nickel content in the single atom catalyst for carbon dioxide conversion of Example 11 (1.61Ni—NSC-2) was measured as 1.60 wt %, and the nickel content in the single atom catalyst for carbon dioxide conversion of Example 12 (1.63Ni—NSC-3) was measured as 1.63 wt. The measurement results are shown in FIG. 1.

### EXPERIMENTAL EXAMPLE 2

The single atom catalysts for carbon dioxide conversion of Comparative Example 2 (1.22Ni—N—C), Example 1 (1.37Ni—N2-C), Example 2 (1.50Ni—N1-C), and Example 3 (3.02Ni—N3-C) were analyzed by X-ray diffraction and the results are shown in FIG. 2. Since a nickel peak was not found in the diffraction analysis patterns of Comparative Example 2 and Examples 1 to 3, it was confirmed that nickel was unlikely to be present as a nanoparticle and was contained on the carbon support as a single atom.

### EXPERIMENTAL EXAMPLE 3

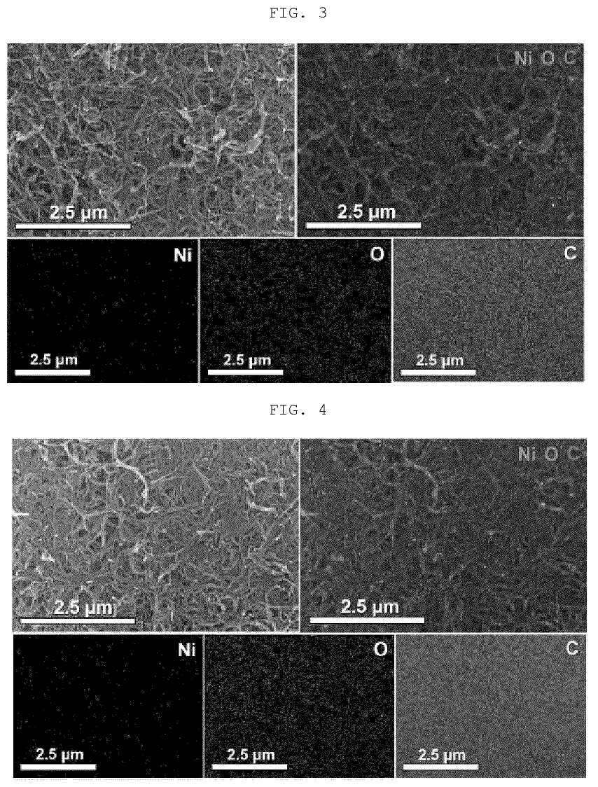

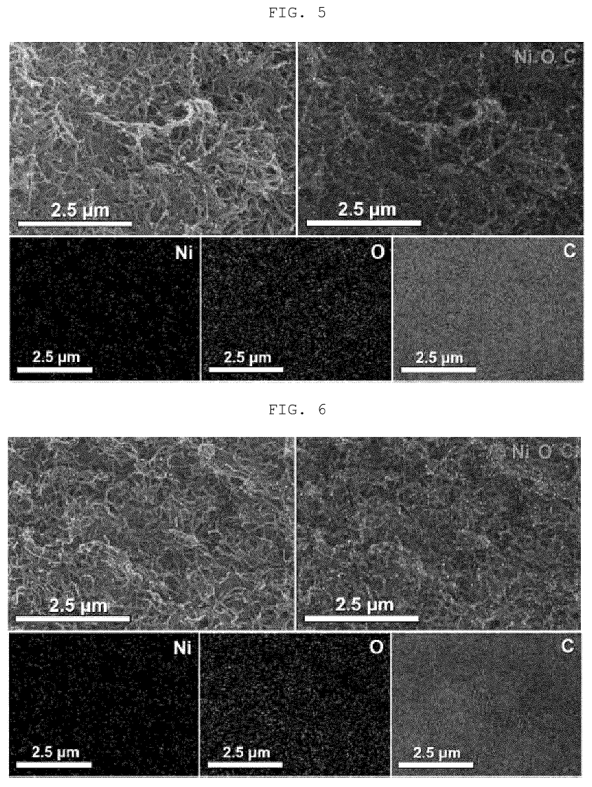

Images of the single atom catalysts for carbon dioxide conversion of Comparative Example 2 (1.22Ni—N—C), Example 1 (1.37Ni—N2-C), Example 2 (1.50Ni—N1-C), and Example 3 (3.02Ni—N3-C) taken by a scanning electron microscope and by energy dispersive spectrometry are shown in FIG. 3 (Comparative Example 2), FIG. 4 (Example 1), FIG. 5 (Example 2), and FIG. 6 (Example 3), respectively. Multi-walled carbon nanotubes were confirmed in the scanning electron microscope image, and other materials which look like the nanoparticles were not confirmed. It was confirmed from the energy dispersive spectrometry image that nickel was evenly dispersed in the multi-walled carbon nanotubes and there were no impurities.

### EXPERIMENTAL EXAMPLE 4

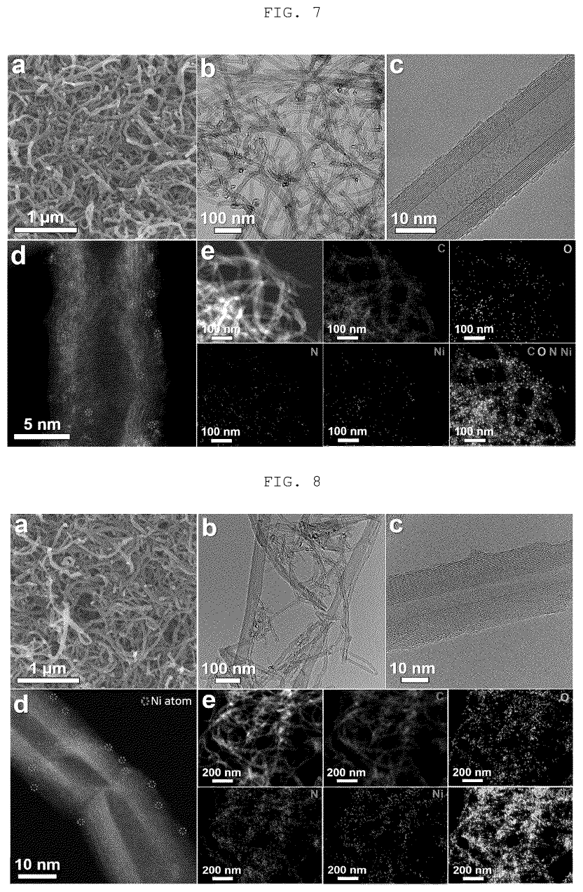

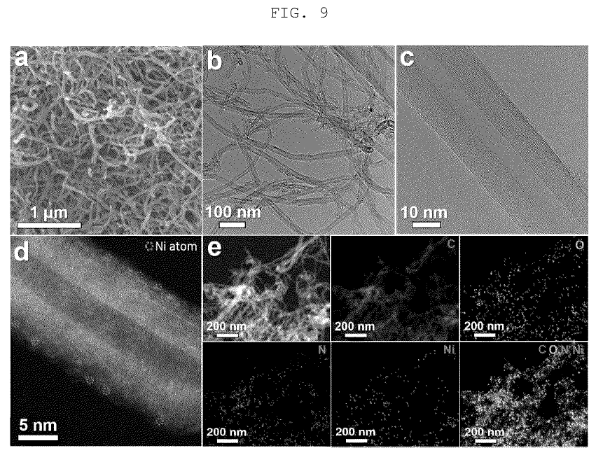

Images of the single atom catalysts for carbon dioxide conversion of Comparative Example 2 (1.22Ni—N—C), Example 1 (1.37Ni—N2-C), Example 2 (1.50Ni—N1-C), and Example 3 (3.02Ni—N3-C) taken by (a) a scanning electron microscope, (b) a transmission electron microscope, (c) a high resolution transmission electron microscope, and (d) an atomic unit analysis scanning transmission electron microscope, and an image analyzed by (e) transmission electron microscope energy dispersive spectrometry are shown in FIG. 7 (Comparative Example 2), FIG. 8 (Example 1), FIG. 9 (Example 2), and FIG. 10 (Example 3), respectively.

It was confirmed from the images that there were no nickel nanoparticles outside and inside the multi-walled carbon nanotubes, a nickel single atom which looked like a white dot was confirmed from the image taken by (d) the atomic unit analysis scanning transmission electron microscope, and it was confirmed that the nickel single atom was fixed well on the multi-walled carbon nanotube.

### EXPERIMENTAL EXAMPLE 5

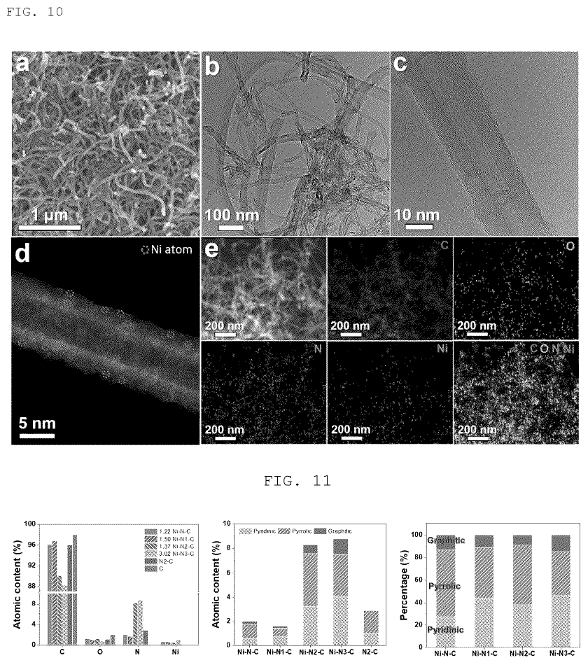

X-ray photoelectron spectroscopy analysis of the single atom catalysts for carbon dioxide conversion of Comparative Example 2 (1.22Ni—N—C), Example 1 (1.37Ni—N2-C), Example 2 (1.50Ni—N1-C), and Example 3 (3.02Ni—N3-C) was performed and the results are shown in FIG. 11. It was confirmed that a catalyst having a high nitrogen content may be obtained when the preparation was performed by adding 1,3,5-triazine-2,4,6-triamine for nitrogen doping (Examples 1, 2, and 3) and simultaneously covering the crucible with the cover (Examples 1 and 3), and also, when the amount of the nickel precursor used was doubled (Example 3), a catalyst having the highest nitrogen content and nickel content may be obtained.

### EXPERIMENTAL EXAMPLE 6

The single atom catalysts for carbon dioxide conversion of Example 3 (3.02Ni—N3-C), Example 4 (1.81Ni—N3-C), Example 5 (2.04Ni—N3-C), and Example 6 (3.44Ni—N3-C) was analyzed by X-ray diffraction, and the results are shown in FIG. 12. Since a nickel peak was not found in the diffraction analysis patterns of Examples 3 to 5, it was confirmed that nickel was unlikely to be present as a nanoparticle and was contained on the carbon support as a single atom. However, since a nickel peak was confirmed in the diffraction analysis pattern of the single atom catalyst for carbon dioxide conversion of Example 6, it was confirmed that nickel was present as a nanoparticle along with the single atom catalyst when the heat treatment temperature was 900° C.

### EXPERIMENTAL EXAMPLE 7

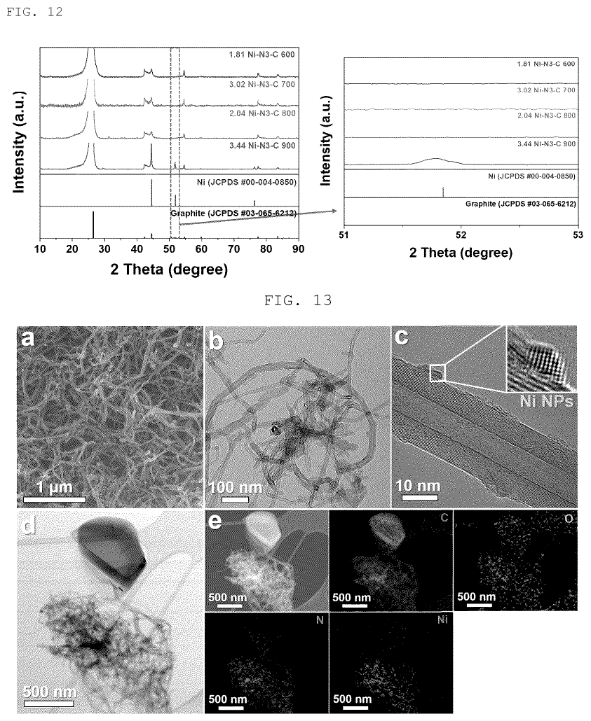

Images of the single atom catalysts for carbon dioxide conversion of Example 3 (3.02Ni—N3-C), Example 4 (1.81Ni—N3-C), and Example 6 (3.44Ni—N3-C) taken by (a) a scanning electron microscope, (b) a transmission electron microscope, (c) a high resolution transmission electron microscope, and (d) an atomic unit analysis scanning transmission electron microscope, and an image analyzed by (e) transmission electron microscope energy dispersive spectrometry are shown in FIG. 10 (Example 3), FIG. 13 (Example 4), and FIG. 14 (Example 6), respectively. It was confirmed from the results that when the heat treatment was performed at 900° C., nickel was present as a single atom and a nanoparticle, which became a cause of decreased carbon monoxide selectivity and production rate. In addition, when the heat treatment was performed at 600° C., it was confirmed that nickel had a smaller particle size than that treated at 900° C., but was partly present as a nanoparticle.

### EXPERIMENTAL EXAMPLE 8

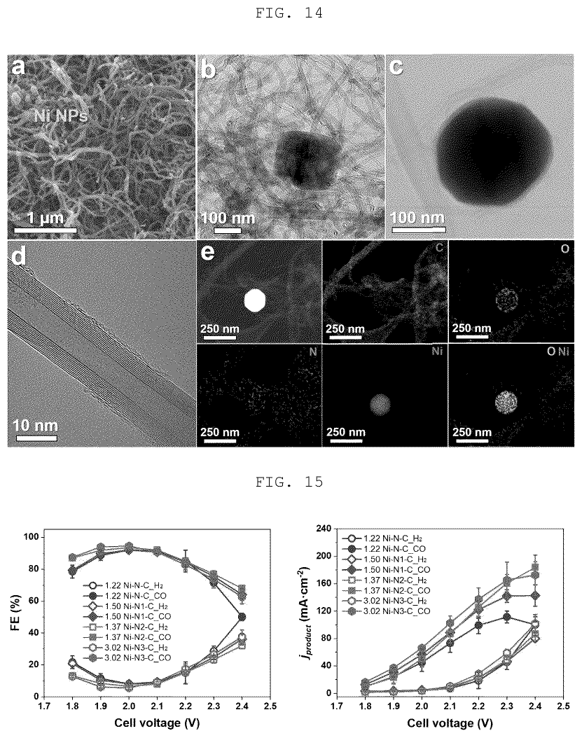

Carbon monoxide (CO)/hydrogen (H₂) selectivity (FE, left) and carbon monoxide (CO)/hydrogen (H₂) production rate (j_{product}, right) of the single atom catalysts for carbon dioxide conversion of Comparative Example 2 (1.22Ni—N—C), Example 1 (1.37Ni—N2-C), Example (1.50Ni—N1-C), and Example 3 (3.02Ni—N3-C) are shown in FIG. 15. All carbon dioxide reduction performance evaluation experiments were performed by injecting carbon dioxide humidified in a zero-gap single cell using a membrane electrode assembly (MEA), and as an anolyte of an oxidation electrode, 1 M KOH was used. At this time, all reduction performance evaluation experiments except for FIG. 18 were performed using a Fumasep FAA-3-50 anion exchange membrane. Carbon monoxide selectivity was found to be 91.94% in Example 8, 93.4% in Example 1, 91.93% in Example 2, and 94.52% in Example 3 under the conditions of 2.0 V. The production rate of carbon monoxide accordingly was confirmed in the right graph.

### EXPERIMENTAL EXAMPLE 9

The catalysts of Comparative Example 2 (1.22Ni—N—C), Example 1 (1.37Ni—N2-C), Example 2 (1.50Ni—N1-C), Example 3 (3.02Ni—N3-C), and Comparative Example 5 (silver nanoparticles, Ag NPs) were analyzed using electrochemical impedance spectroscopy and are shown in FIG. 16. It was shown that charge transfer resistance (R_{ct}) was different from each example and comparative example. All nickel single atom catalysts had charge transfer resistance lower than commercial silver nanoparticles, and this means that a higher current density (production rate) may be obtained under the same voltage conditions during an electrochemical reaction.

### EXPERIMENTAL EXAMPLE 10

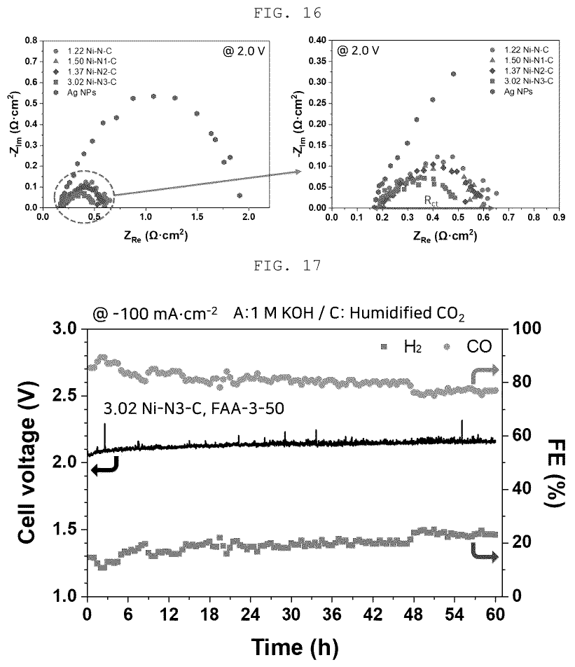

Stability of carbon monoxide (CO)/hydrogen (H₂) conversion of the single atom catalyst for carbon dioxide conversion according to Example 3 (3.02Ni—N3-C) was analyzed by cell voltage (left y axis) and selectivity (right y axis) over time and is shown in FIGS. 17 and 18. Performance evaluation for carbon monoxide production by the carbon dioxide reduction reaction was carried out in the conditions of injection carbon dioxide under humidifying conditions using a membrane electrode assembly manufactured using Fumasep FAA-3-50 and Dioxide Materials Sustainion X37-50 Grade T which are representative anion exchange membranes. As a result of carrying out the electrochemical reaction under constant current (−100 mA·cm⁻²) conditions, it was confirmed that there was a difference in selectivity depending on the used anion exchange membrane, but considering that cell voltage and carbon monoxide selectivity were stable, it was confirmed that the nickel single atom catalyst was firmly incorporated on the carbon support.

### EXPERIMENTAL EXAMPLE 11

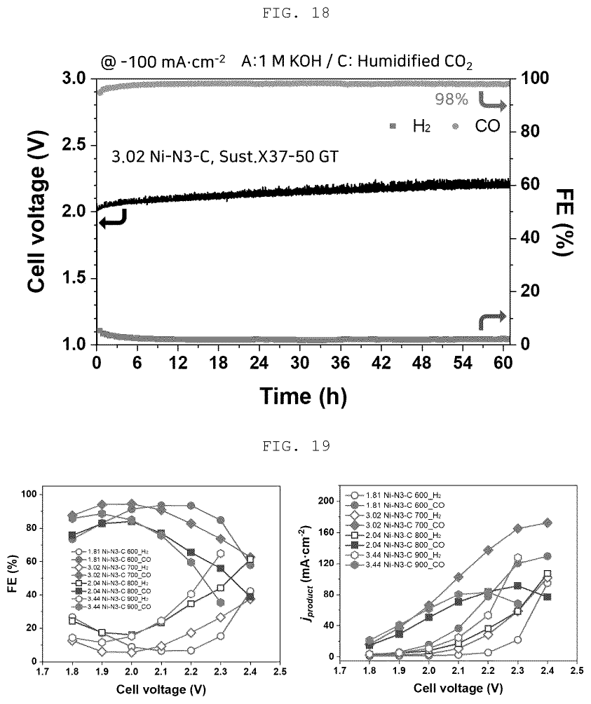

Carbon monoxide (CO)/hydrogen (H₂) selectivity (FE, left) and carbon monoxide (CO)/hydrogen (H₂) production rate (j_{product}, right) of the single atom catalysts for carbon dioxide conversion of Example 3 (3.02Ni—N3-C 700), Example 4 (1.81Ni—N3-C 600), Example 5 (Ni—N3-C 800), and Example 6 (3.44Ni—N3-C 900) are shown in FIG. 19. It was confirmed that the carbon monoxide selectivity and the carbon monoxide production rate were different depending on the heat treatment temperature.

### EXPERIMENTAL EXAMPLE 12

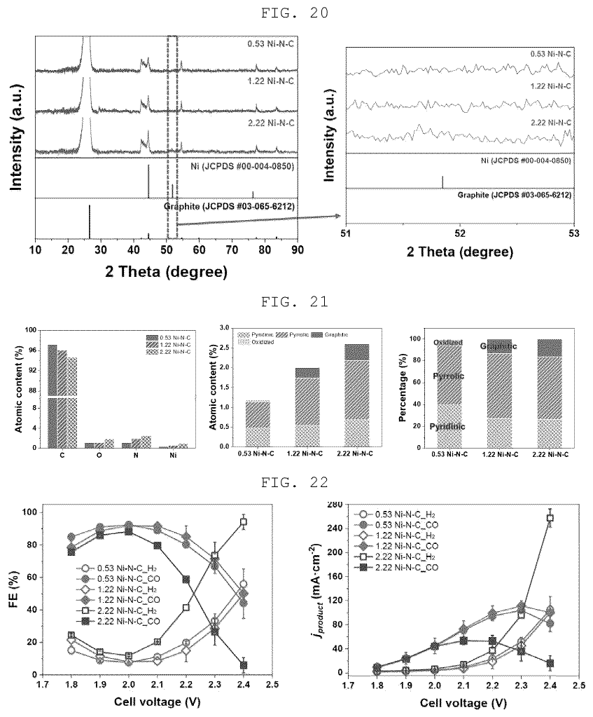

The single atom catalysts for carbon dioxide conversion of Comparative Example 1 (0.53Ni—N—C), Comparative Example 2 (1.22Ni—N—C), and Comparative Example 3 (2.22Ni—N—C) were analyzed by X-ray diffraction and the results are shown in FIG. 20. Since a nickel peak was not found in the diffraction analysis patterns of Comparative Examples 1 to 3, it was confirmed that nickel was unlikely to be present as a nanoparticle and was contained on the carbon support as a single atom.

### EXPERIMENTAL EXAMPLE 13

The single atom catalysts for carbon dioxide conversion of Comparative Example 1 (0.53Ni—N—C), Comparative Example 2 (1.22Ni—N—C), and Comparative Example 3 (2.22Ni—N—C) were analyzed by X-ray photoelectron spectroscopy and the results are shown in FIG. 21. It was confirmed that the nitrogen content of the single atom catalyst for carbon dioxide conversion according to Comparative Example 1 was increased to 1.2 at %, the nitrogen content of the single atom catalyst for carbon dioxide conversion according to Comparative Example was increased to 2 at %, and the nitrogen content of the single atom catalyst for carbon dioxide conversion according to Comparative Example 3 was increased to 2.6 at %, and the content of the nickel atom was increased to 0.53 wt % in Comparative Example 1, 1.22 wt % in Comparative Example 2, and 2.22 wt % in Comparative Example 3.

### EXPERIMENTAL EXAMPLE 14

Carbon monoxide (CO)/hydrogen (H₂) selectivity (FE, left) and carbon monoxide (CO)/hydrogen (H) production rate (j_{product}, right) of the single atom catalysts for carbon dioxide conversion of Comparative Example 1 (0.53Ni—N—C), Comparative Example 2 (1.22Ni—N—C), and Comparative Example 3 (2.22Ni—N—C) are shown in FIG. 22. It was confirmed that the carbon monoxide selectivity was found to be 92.96% in Comparative Example 1, 91.94% in Comparative Example 2, and 88.76% in Comparative Example 3 under the conditions of 2.0 V. The production rate of carbon monoxide accordingly was confirmed in the right graph. The single atom catalysts in Comparative Examples 1, 2, and 3 were prepared by adjusting the amounts of nickel (II) acetate tetrahydrate and 1,10-pheanathrolin monohydrate while maintaining Ni:phen mole ratio=1:3, and it was confirmed that when a Ni content was increased to 2.22 wt %, carbon monoxide selectivity and production rate were decreased. However, in Examples 1 and 3, though the amount of nickel (II) acetate tetrahydrate or 1,10-phenanthrolin monohydrate used was smaller than that of Comparative Example 3, when the heat treatment was carried out by adding a nitrogen-containing material, it was confirmed that nitrogen doped onto the carbon support was present, so that a structure which may maximize the carbon monoxide selectivity and production rate was formed.

[symbol]

### EXPERIMENTAL EXAMPLE 15

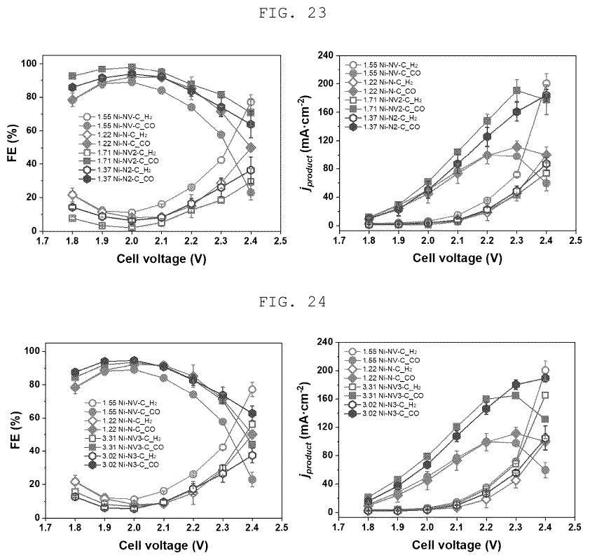

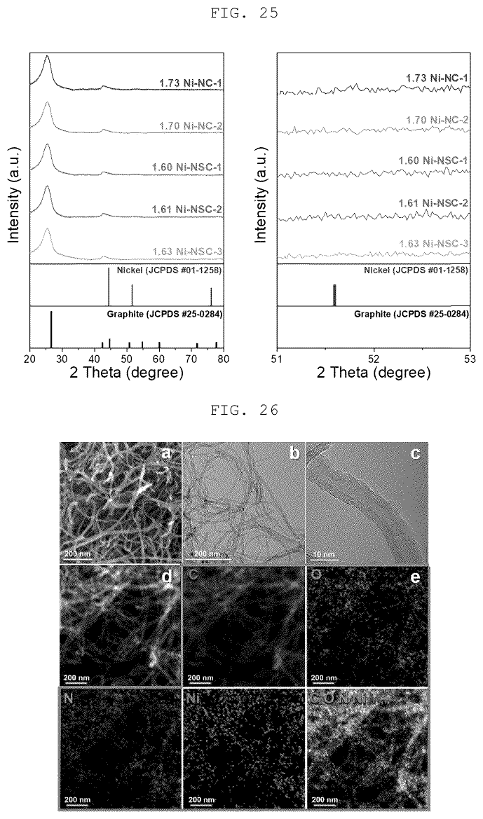

Carbon monoxide (CO)/hydrogen (H₂) selectivity (FE, left) and carbon monoxide (CO)/hydrogen (H₂) production rate (j_{product}, right) of the single atom catalysts for carbon dioxide conversion of Example 7 (1.71Ni—NV2-C), Comparative Example 4 (1.55Ni—NV—C), Example 1(1.37Ni—N2-C), and Comparative Example 2 (1.22Ni—N—C) are shown in FIG. 23, and carbon monoxide (CO)/hydrogen (H₂) selectivity (FE, left) and carbon monoxide (CO)/hydrogen (H₂) production rate (j_{product}, right) of the single atom catalysts for carbon dioxide conversion of Example 8 (3.31Ni—NV3-C), Comparative Example 4 (1.55Ni—NV—C), Example 3 (3.02Ni—N3-C), and Comparative Example 2 (1.22Ni—N—C) are shown in FIG. 24. The single atom catalysts for carbon dioxide conversion of Example 7 (1.71Ni—NV2-C), Example 8 (3.31Ni—NV3-C), and Comparative Example 4 (1.55Ni—NV—C) synthesized to have Ni:phen mole ratio=1:2, and were compared with those of Example 1 (1.37Ni—N2-C), Example 3 (3.02Ni—N3-C), and Comparative Example 2 (1.22Ni—N—C) and shown, respectively.

Example 7 (1.71Ni—NV2-C) and Example 1 (1.37Ni—N2-C) showed higher carbon monoxide selectivity and production rate than Comparative Example 4 (1.55Ni—NV—C) and Comparative Example 2 (1.22Ni—N—C) in which nitrogen was not doped onto the carbon support, and Example 7 (1.71Ni—NV2-C) showed higher carbon monoxide selectivity and production rate than Example 1 (1.37Ni—N2-C). Thus, it was shown that when the catalyst was synthesized under the conditions of Ni:phen mole ratio=1:2, carbon monoxide selectivity and production rate were further increased as compared with the conditions of Ni:phen mole ratio=1:3.

Example 8 (3.31Ni—NV3-C) and Example 3 (3.02Ni—N3-C) showed higher carbon monoxide selectivity and production rate than Comparative Example 4 (1.55Ni—NV—C) and Comparative Example 2 (1.22Ni—N—C) in which nitrogen was not doped onto the carbon support, and Example 8 (3.31Ni—NV3-C) had a somewhat lower carbon monoxide selectivity than Example 3 (3.02Ni—N3-C), but showed a high production rate under most of the voltage conditions. Thus, it was shown that the coordination bonding environment of a single atom and nitrogen and the content and environment of nitrogen doped onto the carbon support may affect the selectivity and the production rate of the carbon dioxide reduction reaction, and when the method presented in the present specification was used, various single atom catalysts suitable for the purpose may be synthesized.

### EXPERIMENTAL EXAMPLE 16

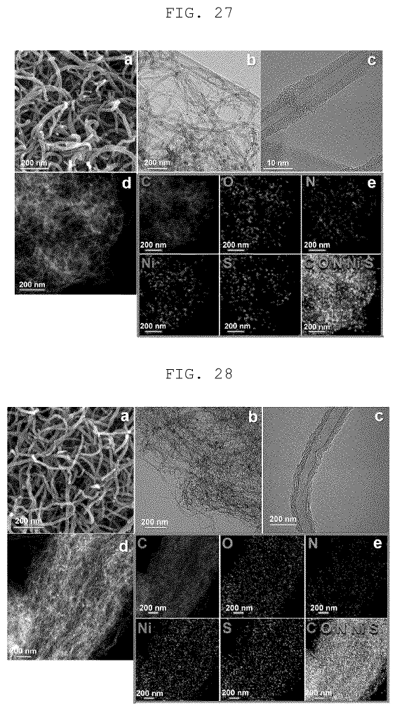

Images of the single atom catalysts for carbon dioxide conversion of Example 9 (1.70Ni—N3-C), Example 11 (1.61Ni—NSC-2), and Example 12 (1.63Ni—NSC-3) taken by (a) a scanning electron microscope, taken by (b) a transmission electron microscope, taken by (c) a high resolution transmission electron microscope, taken by (d) a transmission electron microscope, and analyzed by (e) transmission electron microscope energy dispersive spectrometry are shown in FIG. 26 (Example 9), FIG. 27 (Example 11), and FIG. 28 (Example 12), respectively.

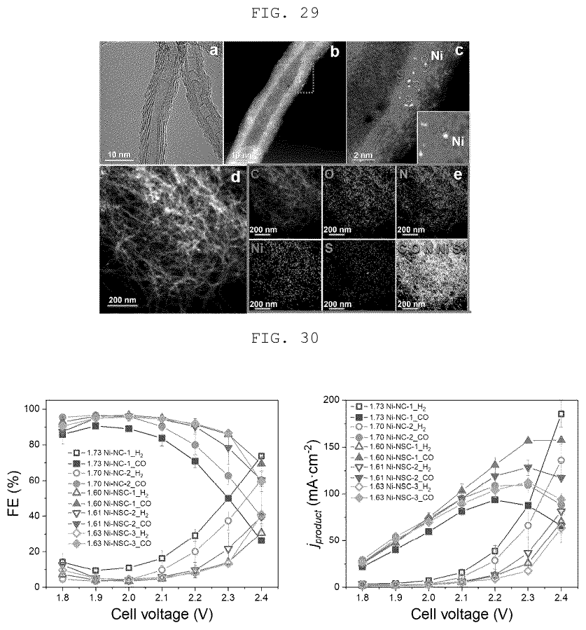

Images of the single atom catalyst for carbon dioxide conversion of Example 10 (1.60Ni—NSC-1) taken by (a) a high resolution transmission electron microscope, (b, c) an atomic unit analysis scanning transmission electron microscope, and (d) a scanning transmission electron microscope, and an image analyzed by (e) transmission electron microscope energy dispersive spectrometry are shown in FIG. 29 (Example 10).

According to FIGS. 26, 27, 28, and 29, it was confirmed that nickel was unlikely to be present as a nanoparticle and was likely to be present as a single atom catalyst. In addition, nitrogen, sulfur, and nickel were evenly dispersed well in the carbon support.

### EXPERIMENTAL EXAMPLE 17

Carbon monoxide (CO)/hydrogen (H₂) selectivity (FE, left) and carbon monoxide (Co)/hydrogen (H₂) production rate (j_{product}, right) of the single atom catalysts for carbon dioxide conversion according to Example 9 (Ni—NC-2), Example 10 (Ni—NSC-1), Example 11 (Ni—NSC-2), and Example 12 (Ni—NSC-3) are shown in FIG. 30. All carbon dioxide reduction performance evaluation experiments were performed identically to the Experimental Example 8.

Carbon monoxide selectivity was found to be 95.83% in Example 9, 96.65% in Example 10, 95.93% in Example 11, and 95.55% in Example 12 under the conditions of 2.0 V. The carbon monoxide production rate accordingly was as shown in the right graph of FIG. 30. Thus, it was confirmed that 1,3,5-triazine-2,4,6-triamine and thiourea were used together to prepare a catalyst heterogeneously doped with nitrogen and sulfur, and in this case, the carbon dioxide selectivity and the production rate were improved, and in particular, the production rate was greatly improved.

The method of preparing a single atom catalyst for carbon dioxide conversion may produce a single atom catalyst for carbon dioxide conversion having a high carbon monoxide selectivity, a high carbon monoxide production rate, and stability during a reduction reaction of carbon dioxide.

The method of preparing a single atom catalyst for carbon dioxide conversion may produce a single atom catalyst for carbon dioxide conversion having a high carbon monoxide selectivity, a high carbon monoxide production rate, a high hydrogen selectivity, a high hydrogen production rate, and stability during a reduction reaction of carbon dioxide.

The single atom catalyst for carbon dioxide conversion according to the present invention has a low metal content and is inexpensive to produce.

The single atom catalyst for carbon dioxide conversion according to the present invention may selectively control a composition ratio of synthetic gas by adjusting a chemical species of a metal ion or a content of a metal ion included in the single atom catalyst for carbon dioxide conversion.

Hereinabove, although the present specification has been described by specified matters and specific exemplary embodiments, they have been provided only for assisting in the entire understanding of the present invention. Therefore, the present invention is not by the specific matters limited to the exemplary embodiments. Various modifications and changes may be made by those skilled in the art to which the present invention pertains from this description. Therefore, the spirit described in the present specification should not be limited to the above-described exemplary embodiments, and the following claims as well as all modified equally or equivalently to the claims are intended to fall within the scope and spirit of the specification.

What is claimed is:

1. A method of preparing a single atom catalyst for carbon dioxide conversion, the method comprising:
dispersing a carbon support in a first solvent to prepare a carbon support solution;
mixing a metal ion precursor and a metal ion-bonded precursor with a second solvent to prepare a metal ion precursor solution;
mixing and reacting the carbon support solution, the metal ion precursor solution, and a nitrogen-containing material to prepare a single atom composite solution;
drying the single atom composite solution to prepare a single atom composite including a carbon support and a metal ion; and
heat-treating the single atom composite to prepare a single atom catalyst,
wherein the metal ion is bonded in the form of a single atom on the carbon support.

2. The method of preparing a single atom catalyst for carbon dioxide conversion of claim 1, wherein the metal ion is bonded in the form of a single atom and a nanoparticle on the carbon support.

3. The method of preparing a single atom catalyst for carbon dioxide conversion of claim 1, wherein the nitrogen-containing material includes a multipolymer of cyanamide or a derivative thereof.

4. The method of preparing a single atom catalyst for carbon dioxide conversion of claim 1, wherein the nitrogen-containing material includes one or more sulfur (S) atoms.

5. The method of preparing a single atom catalyst for carbon dioxide conversion of claim 1, wherein the nitrogen-containing material includes thiourea or a derivative thereof.

6. The method of preparing a single atom catalyst for carbon dioxide conversion of claim 1, wherein the heat treatment is performed at a temperature of 600 to 900° C. under an inert gas atmosphere.

7. The method of preparing a single atom catalyst for carbon dioxide conversion of claim 1, wherein the heat treatment is performed with indirect heating inside a container provided with a cover on an upper portion, from which produced gas slowly escapes.

8. The method of preparing a single atom catalyst for carbon dioxide conversion of claim 1, wherein the reaction in the preparing of a single atom composite solution is performed by heating with refluxing at a temperature of 40 to 80° C.

9. The method of preparing a single atom catalyst for carbon dioxide conversion of claim 1, wherein the carbon support is selected from the group consisting of carbon black, acetylene black, Ketjen black, Denka black, thermal black, channel black, furnace black, lamp black, carbon nanofiber, graphene, graphene nanoribbon, fullerene, single-walled carbon nanotube, double-walled carbon nanotube, multi-walled carbon nanotube, graphite, graphite nanofiber, and fullerene.

10. The method of preparing a single atom catalyst for carbon dioxide conversion of claim 1, wherein the carbon support is doped with one or more non-metal elements selected from the group consisting of nitrogen, oxygen, boron, phosphorus, and sulfur.

11. The method of preparing a single atom catalyst for carbon dioxide conversion of claim 1, wherein the metal ion is one or more selected from the group consisting of a nickel ion, a cobalt ion, an iron ion, a copper ion, and a manganese ion.

12. A single atom catalyst for carbon dioxide conversion comprising:
a carbon support;
a nitrogen atom; and
one or more metal atoms positioned on the carbon support.

13. The single atom catalyst for carbon dioxide conversion of claim 12, wherein the metal atom is positioned to be dispersed in the form of a single atom on the carbon support and is not in contact with other metal elements.

14. The single atom catalyst for carbon dioxide conversion of claim 12, wherein the nitrogen atom is positioned on a surface of the carbon support, and the metal atom coordinates with the nitrogen atom.

15. The single atom catalyst for carbon dioxide conversion of claim 12, wherein the single atom catalyst for carbon dioxide conversion has a carbon monoxide selectivity of 20% or more during a carbon dioxide reduction reaction.

16. The single atom catalyst for carbon dioxide conversion of claim 12, wherein a product from the carbon dioxide reduction reaction with the single atom catalyst for carbon dioxide conversion includes hydrogen and carbon monoxide.

17. The single atom catalyst for carbon dioxide conversion of claim 12, wherein the single atom catalyst for carbon dioxide conversion selectively controls a ratio of hydrogen: carbon monoxide during the carbon dioxide reduction reaction.
